(19) United States
(12) Patent Application Publication
(10) Pub. No.: US 2026/0284947 A1
(43) Pub. Date: Sep. 24, 2026

(54) Method for Producing Radar Sensor Covers

(71) Applicant: Bayerische Motoren Werke Aktiengesellschaft, Muenchen (DE)

(72) Inventors: Jonathan ROTH, Muenchen (DE); Martin SCHNEEBAUER, Muenchen (DE)

(21) Appl. No.: 19/475,304

(22) PCT Filed: May 22, 2024
(86) PCT No.: PCT/EP2024/064018

§ 371 Date: Oct. 14, 2025

(30) Foreign Application Priority Data
Jun. 15, 2023 (DE) 10 2023 115 580.6

(51) Int. Cl. B29C 45/26; B29C 45/76; B29L 31/34

(52) U.S. Cl. CPC B29C 45/2673; B29C 45/76; B29C 2945/7615; B29C 2945/76287; B29L 2031/3456

(57) ABSTRACT

A method for producing radar sensor covers includes characterizing a plurality of differently colored plastics materials on the basis of at least their dielectric constants, selecting one of the plastics materials and determining an optimal thickness of the radar sensor cover to be produced in at least one radar transmission range, and processing the selected plastics material in a manufacturing method using a mold, in which the thickness of the radar sensor cover produced can be adjusted to the optimal thickness, for producing the radar sensor cover.

### BACKGROUND AND SUMMARY

The present disclosure relates to a method for producing radar sensor covers, in particular for motor vehicles.

Radar sensor covers are used in motor vehicles to cover radar devices toward the visible side or hide them from view. For example, these can be short-range or long-range radar systems which operate in the range of 76/77 GHz and are hidden for example behind bumper covers, radomes or other visible components of the vehicle. The radar sensor cover should, on the one hand, ensure an appealing appearance for the customer that, if possible, matches the color and appearance of the rest of the vehicle and, on the other hand, offer a low level of effective transmission loss.

It is known that radar sensor covers are designed to multiples of half of the wavelength in the material (depending on the dielectric constant) in order to possess optimal radar transparency. Different materials possess different dielectric constants, which leads to the thickness of the cover being different in each case depending on the material used. Due to the differences in the refractive index of the different materials, each radome has to be designed with its own specific thickness. This normally means a new tool per radome variant. Additional painting of the components leads to reduced radar transparency.

Against this background, an object of the present disclosure is to indicate how radar sensor covers with high radar transparency can be produced in an improved and cost-effective manner.

This object is achieved by a method for producing radar sensor covers according to to the present disclosure. Additional advantageous embodiments can be found in the following description.

A method for producing radar sensor covers is disclosed in accordance with various embodiments, comprising the steps of:
a) characterizing a plurality of plastic materials of various colorings on the basis of at least their dielectric constants,
b) selecting one of the plastic materials and determining an optimal thickness of the radar sensor cover to be produced in at least one radar transmission region, and
c) processing the selected plastic material in a manufacturing process using a molding tool, in which the thickness of the radar sensor cover produced can be adapted to the optimal thickness, to produce the radar sensor cover.

In other words, in the first step, materials—preferably of one class of plastics but with different colorings—are characterized and their dielectric constants are determined. The relationship between the thickness of the radar sensor cover and the reflection and transmission coefficients can take place for example under idealized conditions by transmission line theory. This allows an optimal thickness at which the radar transparency is maximized to be identified for the component. In the next step, a manufacturing process in which the thickness of the components can be easily adapted, for example using tool inserts of different thicknesses, is proposed.

In one embodiment, steps a) to c) are repeated multiple times, and furthermore an optional step bb), in which the molding tool is altered in order to adapt to the optimal thickness determined in step b), is provided between step b) and step c). In the molding tool, multiple identical radar sensor covers can be produced one after another. If for example other colors are desired and the optimal thickness of the radar sensor cover changes as a result, the molding tool is altered accordingly so that, after this, sensor covers with the “new” optimal thickness are manufactured. In this way, optimally adapted sensor covers with different colors can be obtained from one tool with a short lead time.

The manufacturing process for processing the selected plastic materials is preferably an injection molding process. In this process, plasticized plastic material is injected into the molding tool and fills the cavity of the molding tool, which is substantially in the shape of the radar sensor cover to be produced.

The molding tool can have a movably mounted separating frame. This ensures that the molding tool closes completely without visible parting lines being created at the edge of the component.

In one embodiment, the manufacturing process is injection compression molding. In this process, a melt preform of a specified volume or mass is compressed to its final dimensions within the molding tool, as a result of which particularly low component tolerances and good homogeneity of the radar sensor cover are achieved.

Furthermore, the tool can have different tool inserts, by which the thickness of the radar sensor cover produced can be varied. The thickness is adapted at least in a radar transmission region. The radar transmission region here is that region of the radar sensor cover through which the radar radiation is to pass. For example, by using pressure plates of different thicknesses, the distance between the cavity walls in the region of the radar transmission region can be set to an optimum (multiples of half of the wavelength in the material) that corresponds to the plastic material.

The radar sensor cover can be formed completely from the plastic material selected in step b). In an alternative embodiment, in step c), a semi-finished product is inserted into the tool and the selected plastic material is molded over it. The semi-finished product can be for example a standardized component which is the same for all color variants. The semi-finished product can have for example additional functions, such as component heating. The semi-finished product can be for example a pre-molded part which was formed in a preceding injection molding process. The thickness of the semi-finished product as well as its radar transmission properties are also taken into account in this embodiment in order to determine the optimal thickness of the radar sensor cover in the radar transmission region.

The plastic materials have different colorings. Preferably, they are available as fully dyed plastics. This can comprise for example different shades and different opacities. The plastic materials are preferably unfilled plastics which may possibly contain talc as an additional component. Preferably, plastic materials without conductive additives or conductive fillers are used. The plastic materials may contain some recycled plastic. In one embodiment, it is provided that the plurality of plastic materials all belong to the same class of plastics. Examples of possible classes of plastics are PP EPDM, PC and PC-ABS. Depending on the composition, the plastic materials differ at least on the basis of their dielectric constants. This is in relation to the optimal thickness—determined from the point of view of the radar transparency—of the plastic material. Depending on the desired color, a plastic material is selected from the multiplicity of plastic materials characterized.

The radar sensor cover can be for example a radome or a visible plastic component of a motor vehicle, such as a bumper cover, a headlight outer lens, a mirror housing, etc.

Additional advantages, features, and details of the present disclosure can be found in the following description, in which exemplary embodiments are described in detail with reference to the drawings. The features mentioned in the claims and in the description can each be utilized individually or in any combination. If the term “can” is used in this application, this refers to both the technical possibility and to the actual technical implementation.

Exemplary embodiments are explained hereinbelow on the basis of the accompanying drawings.

### BRIEF DESCRIPTION OF THE DRAWINGS

FIG. 1 shows an exemplary way in which the method proceeds,

FIGS. 2 and 3 show an exemplary molding tool for performing the method, and

FIGS. 4A, 4B and 4C show exemplary sensor covers.

### DETAILED DESCRIPTION OF THE DRAWINGS

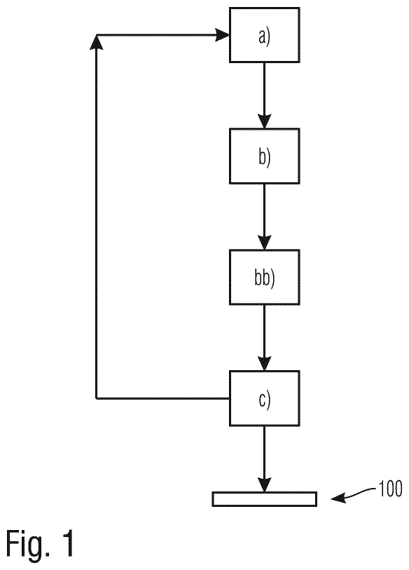

FIG. 1 shows an exemplary way in which the method proceeds for the purpose of producing radar sensor covers. In step a), first a plurality of plastic materials of various colorings is characterized on the basis of at least their dielectric constants; in step b), one of the plastic materials is selected, and this is used to produce the radar sensor cover. Furthermore, an optimal thickness of the radar sensor cover to be produced is determined in at least one radar transmission region. By way of the optimal thickness, the radar sensor cover has the best possible radar transmission. The method uses a molding tool in which the thickness of the sensor cover produced can be adapted to the optimal thickness. In step bb), the molding tool is altered in order to adapt to the optimal thickness determined in step b). For example, tool inserts can be changed, which changes the thickness of the tool cavity and therefore changes the thickness of the radar sensor cover at least in the radar transmission region. Step bb) can be omitted if no adaptation of the molding tool is necessary. In step c), the selected plastic material is injected into the molding tool and cools to produce the radar sensor cover 100. Then, the molding tool 10 is opened and the radar sensor cover is demolded by an ejector assembly 18. The method is then repeated to produce additional radar sensor covers.

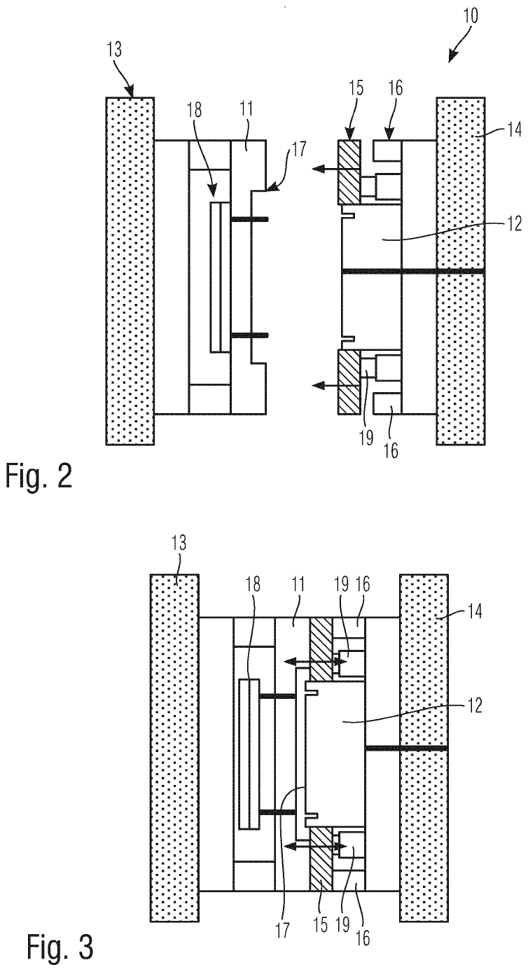

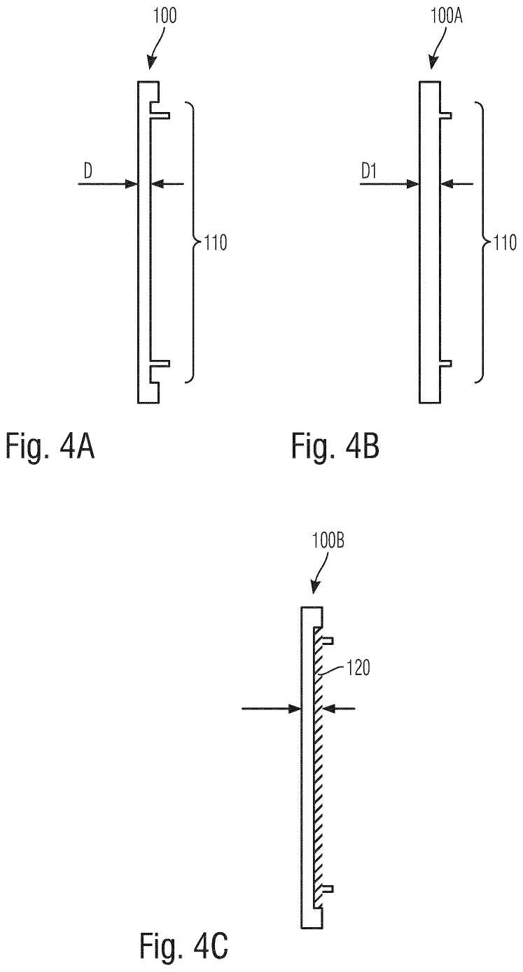

FIGS. 2 and 3 show an exemplary molding tool 10 in the form of an injection molding tool for use in the method. The molding tool 10 has two tool halves 11, 12, which are each mounted on a mounting plate 13, 14. The final position (see FIG. 3) of a movable separating frame 15, which can be displaced by hydraulic cylinders 19, is set by spacers 16 such that the molding tool 10 can be closed to the desired extent. Different optimal thicknesses can be realized in this molding tool 10 using different spacers 16. In the closed state, the tool halves 11, 12 enclose a cavity 17 in which the radar sensor cover 100 is formed. To produce radar sensor covers, the closed cavity 17 is filled with the plastic material (see FIG. 3), and this then results for example in the sensor covers 100 and 100 A with different thicknesses D, D1 in the radar transmission region 110 that are shown in FIGS. 4A and 4B. In an alternative embodiment, a semi-finished product 120 in the form of a pre-molded part is inserted into the molding tool 10 before the injection molding process and the plastic material is molded over it, and this results in the radar sensor cover 100B shown in FIG. 4C.

### LIST OF REFERENCE SIGNS

a), b), bb), c) Method steps
D, D1 Thickness
10 Molding tool
11, 12 Tool halves
13,1 4 Mounting plate
15 Separating frame
16 Spacer
17 Cavity
100, 100A, 100B Radar sensor cover
120 Semi-finished product

1-8. (canceled)

9. A method for producing radar sensor covers, comprising:
a) characterizing a plurality of plastic materials of various colorings on a basis of at least their dielectric constants;
b) selecting one of the plastic materials and determining an optimal thickness of the radar sensor cover to be produced in at least one radar transmission region; and
c) processing the selected plastic material in a manufacturing process using a molding tool, in which a thickness of the radar sensor cover produced is adapted to the optimal thickness to produce the radar sensor cover.

10. The method according to claim 9, comprising:
repeating the steps of characterizing, selecting, and processing; and
altering the molding tool in order to adapt to the optimal thickness determined after the step of selecting and prior to the step of processing.

11. The method according to claim 9,
wherein the manufacturing process is an injection molding process.

12. The method according to claim 9,
wherein the manufacturing process is injection compression molding.

13. The method according to claim 12,
wherein the molding tool has a movably mounted separating frame.

14. The method according to claim 9,
wherein the molding tool has different tool inserts configured to vary the thickness of the radar sensor cover produced.

15. The method according to claim 9, comprising:
inserting a pre-molded part into the molding tool and molding the selected plastic material over the pre-molded part.

16. The method according to claim 9,
wherein the plurality of plastic materials all belong to a same class of plastics.
